(19) United States
(12) Patent Application Publication
(10) Pub. No.: US 2012/0269046 A1
(43) Pub. Date: Oct. 25, 2012

(54) VIBRATING ALARM AND METHOD OF WAKING

(76) Inventor: Mandy Romeu, Deerfield Beach, FL (US)

(21) Appl. No.: 13/092,208

(22) Filed: Apr. 22, 2011

(51) Int. Cl. G04C 21/18; G04G 17/08

(52) U.S. Cl. 368/251; 368/250

(57) ABSTRACT

A device and method for waking a user includes providing a vibrating alarm assembly that features a water-tight shell, a tether physically coupled to the water-tight shell, a vibration-producing element disposed within the water-tight shell, and a timer disposed within the water-tight shell. The timer being communicatively coupled to the vibration-producing element and operable to activate the vibration-producing element at a preselected time of day. The novel vibrating alarm assembly is then inserted within a body cavity of the user.

### FIELD OF THE INVENTION

The present invention relates generally to personal pleasure devices and, more particularly, relates to a personal vibratory device equipped with a timer that can be used to wake a user with a selected vibrational waveform.

### BACKGROUND OF THE INVENTION

Personal vibrators, which are commonly used for sexually stimulating a user, are well known in the art. All known vibrators operate from a battery power source or from a standard plug-in wall power source. The user uses an off/on switch provided on the exterior of the vibrational device to apply power to and engage an electric motor within the vibrator device. Although other types can be used, generally, the electric motor is an offset rotating device with a weight on one side of its rotating driveshaft. During rotation, the offset weight causes the motor to shake, thereby sending a vibration throughout the device, which can be felt outside of the device.

Personal vibrators are utilized for a variety of reasons, for example, to relax muscles or for sexual stimulation. Vibrators are commonly used when a sexual partner is not available or employed as a sexual aid between couples. Vibrators have been deemed by virtually all medical professionals as a safe device that provides a beneficial therapeutic effect for the user.

Currently, the only way to activate a vibrational device is to manually manipulate a switch provided on the exterior of the device. This can be a sliding switch, a rotational switch, a push button, or any other mechanism for coupling a power source to the motor. Therefore, for the vibrational device to become active, the user must actively cause it to become energized.

One vibrational device that has received a bit of notoriety involves an undergarment, e.g., panties, with a vibrational device attached thereto. The vibrational device is activated via remote control, which the wearer of the undergarment can utilize or provide to their partner as part of a sexual game. However, as with all other prior-art vibrational devices, for the vibrational device to become active, the user or a second party must actively cause it to become energized.

Therefore, a need exists to overcome the problems with the prior art as discussed above.

### SUMMARY OF THE INVENTION

The invention provides a vibrating alarm that overcomes the hereinafore-mentioned disadvantages of the heretofore-known devices and methods of this general type and that automatically engages its power supply with a vibrational-generating motor at a determined time so that a user is automatically provided with enjoyable vibrations.

With the foregoing and other objects in view, there is provided, in accordance with the invention, a vibrating alarm assembly that includes a water-tight shell, a tether physically coupled to the water-tight shell and partially disposed at an exterior of the water-light shell, a power source disposed within the water-tight shell, a vibration-producing element disposed within the water-tight shell and coupled to the power source, and a timer disposed within the water-tight shell, communicatively coupled to the vibration-producing element and the power source, and operable to activate the vibration-producing element at a preselected time of day.

In accordance with another feature, the water-tight shell includes a distal end, a proximal end opposite the distal end and coupled to the tether, at least one sidewall between the distal end and a proximal end, and a smooth transition between the distal end and the at least one sidewall.

In accordance with yet one more feature, an embodiment of the present invention also includes an input and a processor, where the processor is communicatively coupled to the input, communicatively coupled to the vibration-producing element, operable to receive from the input a selection from a user of at least one vibrational waveform profile from at least two vibrational waveform profile choices, and operable to cause the vibration-producing element to produce the at least one selection of a vibrational waveform profile choice.

In accordance with a further feature of the present invention, each vibrational waveform profile includes specification of at least one of a vibrational frequency and a vibrational amplitude.

In accordance with another feature, an embodiment of the present invention also includes a memory communicatively coupled to the processor, the memory storing at least two predefined vibrational waveform profiles selectable by the processor for delivery to the vibration-producing element.

In accordance with the present invention, a method for waking a user includes the steps of providing a vibrating alarm assembly that includes a water-tight shell, a tether physically coupled to the water-tight shell, a vibration-producing element disposed within the water-tight shell, and a timer disposed within the water-tight shell, communicatively coupled to the vibration-producing element, and operable to activate the vibration-producing element at a preselected time of day. The method further includes inserting the vibrating alarm assembly within a body cavity of the user.

In accordance with a further feature of the present invention, the method includes removing the vibrating alarm assembly from the body cavity of the user by pulling the tether.

In accordance with another feature, an embodiment of the present invention also includes delivering to the timer at least one vibrational waveform profile selected by the user from at least two vibrational waveform profile choices provided to the user.

In accordance with yet another feature, an embodiment of the present invention includes.

In accordance with a further feature of the present invention, a vibrating alarm assembly includes a water-tight shell defining a distal nose portion, a proximal end portion, a tubular elongated body portion disposed between the distal nose portion and the proximal portion, and a smooth transition region between the distal nose portion and the elongated body portion. A tether is physically coupled to the water-tight shell, a vibration-producing element is disposed within the water-tight shell, a power source is disposed within the water-tight shell, and a timer is disposed within the water-tight shell and is operable to electrically couple the power source to the vibration-producing element at a preselected time of day.

Although the invention is illustrated and described herein as embodied in a vibrating alarm, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the water-tight shell. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a fragmentary, cross-sectional side elevational view of a vibrating alarm assembly in accordance with the present invention;

FIG. 2 is a fragmentary, cross-sectional side elevational view of the vibrating alarm assembly of FIG. 1, with the tether attached to the cap in accordance with the present invention;

FIG. 3 is an exploded perspective view of the vibrating alarm assembly of FIG. 2 in accordance with the present invention;

FIG. 4 is a fragmentary, cross-sectional side elevational view of the water-tight shell of FIGS. 1 and 2 illustrating exemplary physical dimensions of the water-tight shell in accordance with the present invention;

FIG. 5 is a process flow diagram illustrating a method of using the vibrating alarm assembly of FIG. 1; and

FIG. 6 is a side elevational view of a fishing lure that includes a vibrating alarm assembly in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel vibrational device that automatically energizes at a preselected time of day. Embodiments of the invention provide an overall size that comfortably fits within the female's vagina or other body cavity and can comfortably reside there for extended periods of time. In addition, embodiments of the invention provide a programmable vibrational waveform generator that can produce custom designed/selected waveforms, providing amplitudes, frequencies, and lengths of vibration operating times to suit the users preferences.

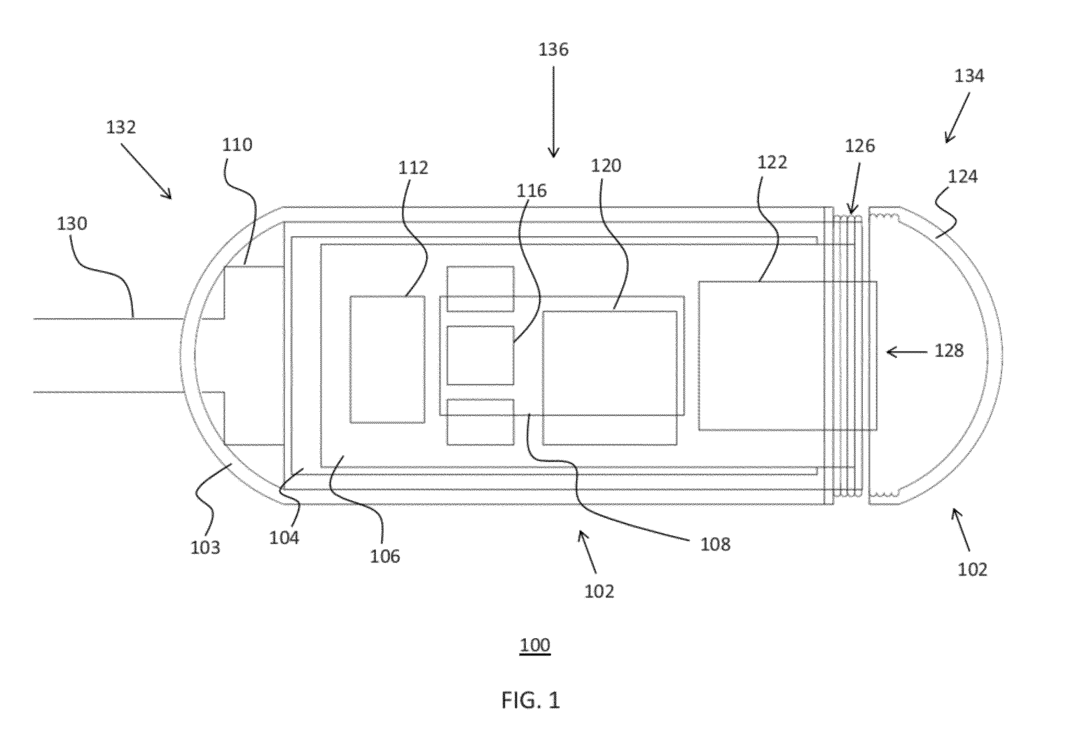

Referring now to FIG. 1, one embodiment of the present invention is shown in a partial schematic view. FIG. 1 shows several advantageous features of the present invention, but, as will be described below, the invention can be provided in several shapes, sizes, combinations of features and components, and varying numbers and functions of the components. The first example of a programmable vibrational device 100, as shown in FIG. 1, includes an outer shell 102 that includes a main body section 103 and a cap 124. The cap 124 can be selectively coupled and decoupled to the main body section 103 of the outer shell 102. In accordance with an embodiment of the present invention, the coupling between the cap 124 and the main body section 103 provides a water-tight seal that prevents moisture from passing from an exterior of the outer shell 102 to the interior of the outer shell 102. This seal can be accomplished by screwing the cap 124 onto a set of threads 126 provided at an end of the main body section 103. Of course, the present invention is not limited to a threaded connection between the main body section 103 and the cap 124. Snap-fitting components, as just one example, can be substituted for the threads 126.

With regard to shape, the outer shell 102 can be described as having a proximal end 132, a distal end 134, and a sidewall 136 connecting the proximal end 132 to the distal end 134. As can be seen in FIG. 1, the outer shell 102 features a smooth transition between the proximal end 132 and the sidewall 136 as well as a smooth transition between the distal end 134 and the sidewall 136. The smooth transition, i.e., one free of discontinuities, allows the inventive device to easily slide within and be removed from a body cavity of a user. It is envisioned that the outer shell 102 will be in the shape of a tube with rounded ends, as is depicted in FIG. 1. However, the invention is not limited to any particular shape of the outer shell 102.

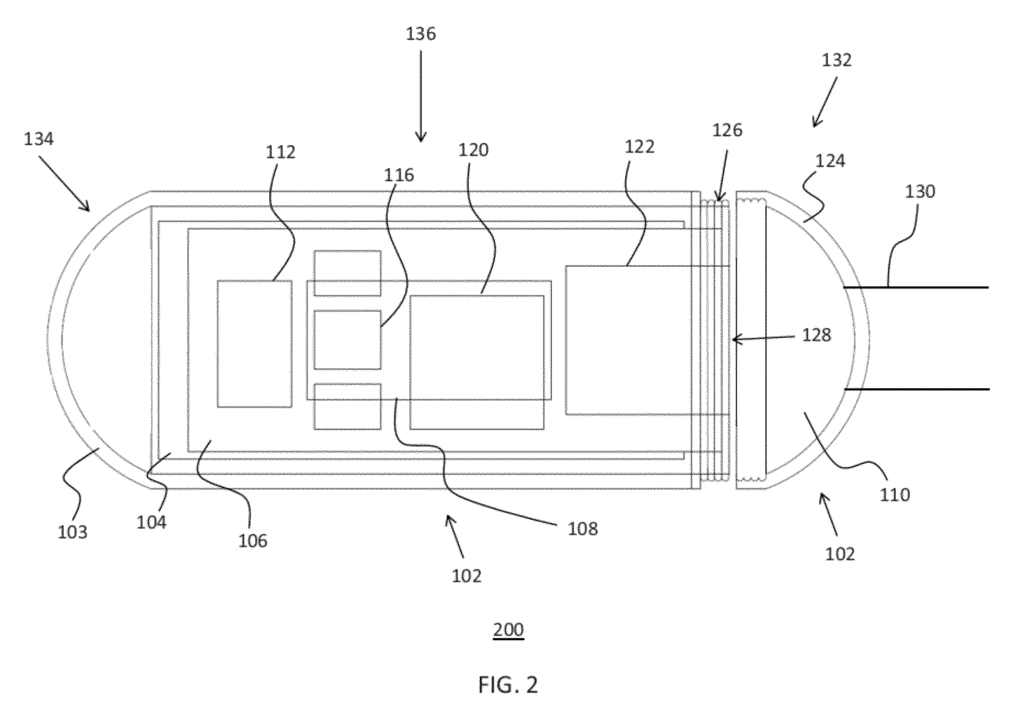

The presently-inventive vibrational device 100 further includes a tether 130 physically coupled to the outer shell 102 at its proximal and 132. In FIG. 1, the tether 130 is shown as passing through the proximal end 132 of the outer shell 102 and having a portion 110 that resides within the proximal end 132 of the outer shell 102. The larger internal portion 110 of the tether 130 prevents the tether 130 from separating, i.e., being removed, from the outer shell 102. As will be explained below, the proximal end 132 is defined by its connection to the tether 130, which allows the entire vibrational device 100 to be easily removed from the body cavity once it is inserted. In other words, in an embodiment where the tether 130 is attached to the cap 124 (shown in FIG. 2), the cap end of the device 100 becomes the proximal end because, in that case, the non-tether end will be inserted first.

In one embodiment of the present invention, the outer shell 102 is formed from or is provided with a conformal coating that provides improved waterproofing properties and/or improved frictional properties. The conformal coating can be, for instance, silicone, plastic, or other materials.

Housed within the outer shell 102 is a printed circuit board 106. The printed circuit board 106 provides physical support and electronic communicative coupling between components supported thereon. It should be noted however, that the present invention is not limited to component coupling by a printed circuit board. Other electronic connections, e.g., wires, between components can be substituted without departing from the spirit and scope of the present invention.

On a first side of the printed circuit board 106 is a controller 120. The controller 120 can be any processing device that is capable of receiving inputs and providing an output as a response to the received inputs. In accordance with an embodiment of the present invention, the controller 120 is an ATMEGA processor manufactured by ATMEL Corp. of San Jose, Calif.

Coupled to the controller 120 is a memory 116. As will be explained below, the memory 116 is able to store information that defines operational modes of the inventive vibrational device 100. For example, the memory can store at least two predefined vibrational waveform profiles that, when utilized, defines the vibrational performance of the device 100. In addition, the memory can store preselected times of the day that the vibrational device 100 will operate.

Also communicatively coupled to the controller 120 is a timer 112. In accordance with one embodiment of the present invention, the timer 112 is a digital counter that either increments or decrements at a fixed frequency, which can be configurable, and that interrupts the controller 120 when reaching the preselected value. Alternatively, the timer 112 can include comparison logic that compares the timer value against a specific value, set by software, that triggers the controller 120 when the timer value matches the preset value. This might be used, for example, to measure events or generate pulse width modulated waveforms to control the speed of motors (using, for example, a class D digital electronic amplifier). The timer 112 can also be a programmable interval timer, which is known in the art and commonly referred to as a “PIT.”

Also coupled to the printed circuit board 106 is a vibration-producing element 108. The vibration-producing element 108 can be any component that, when activated, produces a physical vibration. For example, the vibration-producing element 108 can be an electric motor with an unbalanced mass on its driveshaft. One specific type of vibration-producing element 108 that can be used with the present invention is part number 4HK08C1 from ZHEJIANG YUESUI ELECTRON STOCK CO., LTD of China. Many other vibration-producing devices are known in the art and can be utilized with the present invention as well.

Also present within the water-tight shell 102 is a power source 104, which is illustrated in FIG. 1 as a battery. In accordance with an embodiment of the present invention, exemplary dimensions for the battery power source 104 are about 28 mm in length, 12 mm in width, and 3 mm in height. Additionally, according to one exemplary embodiment of a battery power source 104, the battery output is about 3.7 V. The present invention, however, is not limited to any particular type, shape, dimension, or output of the power source 104.

In operation, the controller 120, upon detection of a timing event communicated by the timer 112, couples the power source 104 to the vibration-producing element 108. Upon receiving power, the vibration-producing element 108 causes the entire device 100 to produce a physical vibration that can be felt from the exterior of the water-tight shell 102.

In accordance with an embodiment of the present invention, the vibrational device 100 is further provided with an input 122, which can include a universal serial bus (USB) connector with an input port 128. The input 122 can also be a wireless receiver, such as a radio frequency (RF) receiver, and can utilize any standard for exchanging data, such as, for example BLUETOOTH. The input 122 is not limited to any physical aspects or data exchanging protocols and can simply be any component that allows signals to be received by the vibrational device 100.

Advantageously, the input 122 can be used to provide the vibrational device 100 with a user's choice of a vibrational waveform profile selected from two or more choices of available vibrational waveform profiles. This selection of profile from the user can be stored in the memory 116 and can be recalled by the controller 124 operating the vibration-producing element 108 in a manner dictated by the vibrational waveform profile. Selectable aspects of the vibrational waveform profiles can be the waveform shape, e.g., sinusoidal, square, saw tooth, and others, the waveform amplitude, e.g., 1 V peaks, 2 V peaks, 3 V peaks, or variations thereof, waveform frequencies, and lengths of time. The waveform profiles can also be variations of waveform shape, waveform amplitude, and waveform frequency, depending on the user's preferences.

In accordance with one embodiment of the present invention, the vibrational device 100 can be coupled to a computing device through the input 122. If the input 122 is a physical connector, such as a USB port, the input will be physically coupled to the computer via, cable. If the input 122 is a wireless receiver, the input will be wirelessly coupled to the computer via wireless signals. Once coupled to the computing device, the input 122 can receive a selection from a user of at least one vibrational waveform profile from at least two vibrational waveform profile choices. In other embodiments, a plurality of vibrational waveform profiles can be preloaded into the memory 116 and the user can select through, for example, a user interface button provided on the device, which of the plurality of vibrational waveform profiles they prefer. Alternatively, the controller 120 can randomly select one of the plurality of available with vibrational waveform profiles stored in the memory 116 and drive the vibration-producing element 108 with that profile once it is selected. The random selection can be each time the tinier 116 causes the controller 120 to engage the vibration-producing element 108 or less frequently.

Referring now to FIG. 2, it can be seen that the tether 130 is attached to the cap 124. In this embodiment, the proximal end 132 and distal end 134 have switched places. In other words, whichever end of the device 200 is attached to the tether 130, that end will be referred to as the proximal end 132 because the other end, the distal end 134, is the end that will be inserted first into the body cavity where the device 200 is to be placed.

When the tether 130 is attached to the cap 124, the base 110 of the tether 130 fills a portion of the void formed within the interior of the cap 124. As FIG. 2 shows, the opening 128 of the input 122 is substantially flush with the end of the set of threads 126. When the cap 124 is fully engaged with the threads 126, the base 110 of the tether 130 contacts and seals the opening 128 of the input 122, providing improved water sealing.

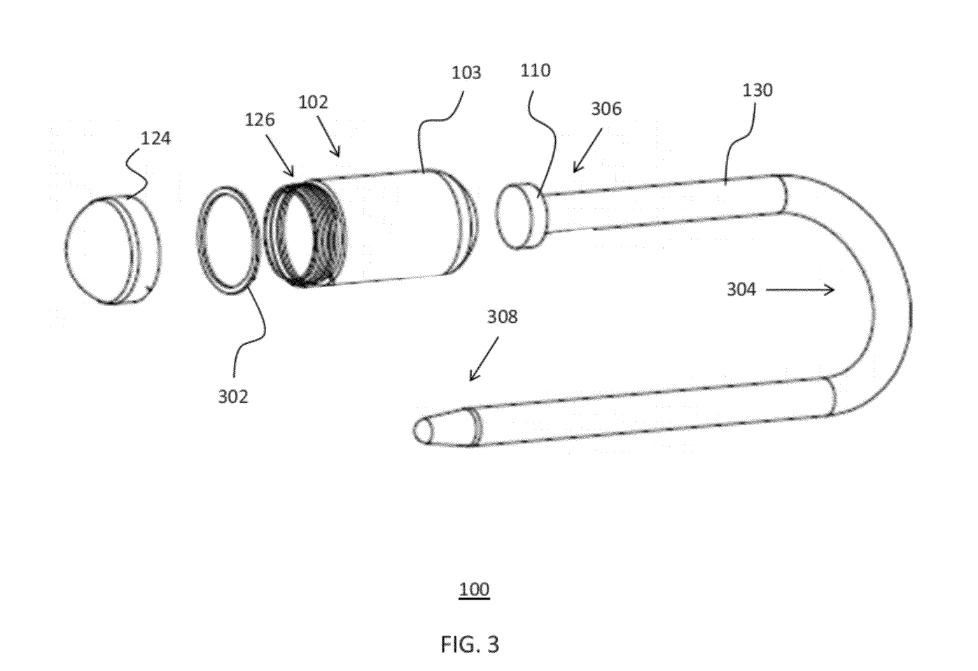

FIG. 3 shows a perspective exploded view of the novel vibrating alarm assembly 100. In particular, the view of FIG. 3 shows the cap 124 separated from the threads 126 of the water-ht shell 102. To provide improved water sealing properties, the present invention provides an optional gasket 302 between the cap 124 and the main body section 103 of the water-tight shell 102.

In particular, FIG. 3 provides a more detailed view of the tether 130. The tether 130 is shown as separated from the main body section 103 of the water-take shell 102. As was described above, the tether 130 can also be attached to the cap 124. As can be clearly seen in FIG. 3 the tether 130 can include a curved portion 304 between a distal end 306 and a proximal and 308 of the tether 130. This “shaped” tether 130 is able to prevent the device 100 from being inserted too far into the body cavity. Because of its shape, it will fit within the contour of the outside shape of the body area surrounding the cavity. Advantageously, the tether 130 will remain in place over the pelvic area, so that it is easily found and accessed for retrieval.

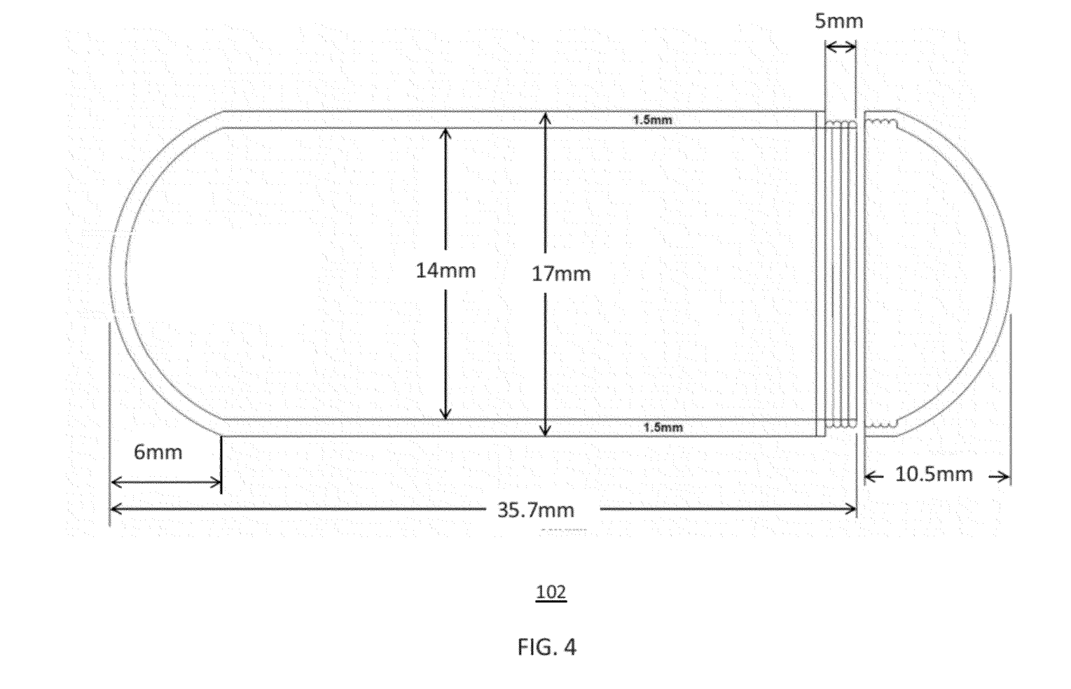

FIG. 4 provides an elevational cross-sectional view of the water-tight shell 102 and provides exemplary dimensions that can be used, in accordance with one embodiment of the present invention, to form the water-tight shell 102. When the device is sealed, i.e., the cap 124 is attached to the main body section 103 of the water-tight shell 102, the overall length of the device 100 is about 41.2 mm. Of course, the present invention is in no way limited to the specific dimensions shown in FIG. 4 or described herein. However, the dimensions shown advantageously provide sufficient room to house the above-describe components, and to comfortably fit within a user's body cavity. The exemplary dimensions shown in FIG. 3 are intended to have a tolerance of about +/−25%.

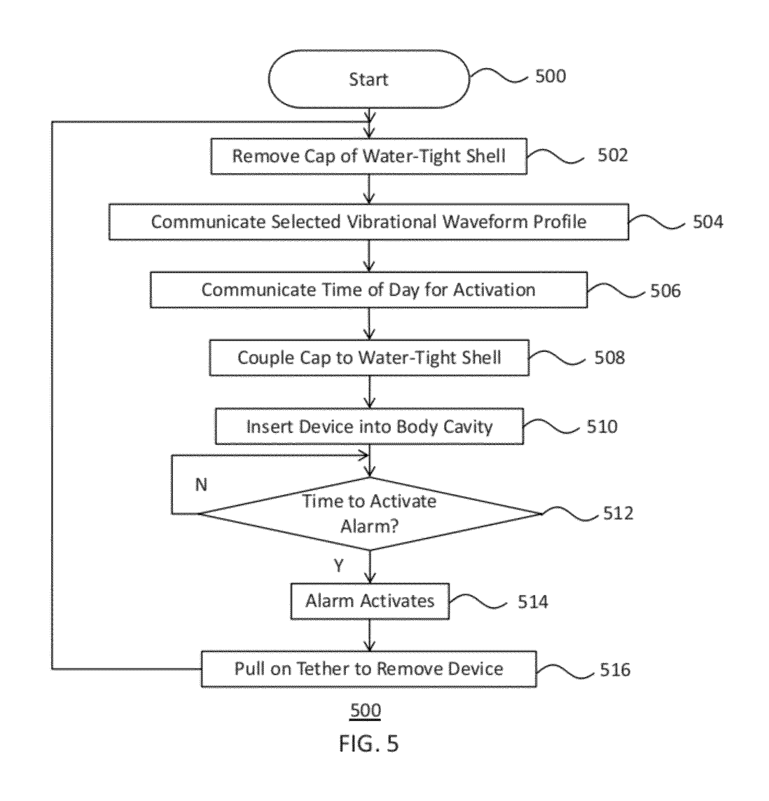

FIG. 5 provides an exemplary process flow diagram illustrating a method for waking a user. The process starts at step 500 and move directly to step 502. In step 502 the user removes the cap 124 of the water-tight shell 102 of the vibrating alarm assembly 100. Once the cap 124 is removed, the input 122 is exposed to the user. In step 504, using the input port 128, the user provides the vibrating alarm assembly 100 with at least one vibrational waveform profile. The profile can be selected by the user from two or more vibrational waveform profile choices that were available to the user to choose from. The choices can be provided, for instance, on a website where the user downloads the waveform profiles to their local computer which is then connected to the inventive device 100. In other embodiments, the waveform profiles can be provided on a disc, a memory stick, or other memory devices that can be communicatively coupled to the input port 128. Furthermore, step 502 can be skipped if the vibrating alarm assembly 100 is provided with a wireless input 122, thereby allowing the user to wirelessly transmit their choice of vibrational waveform profiles to the vibrating alarm assembly 100.

In step 506, the user communicates to the vibrating alarm assembly 100, a time of day for the device to activate. This can include specifying a single time of day, or multiple times throughout the day. It can also include specifying specific days of the week and excluding other days of the week. This communication step can also include specifying specific vibrational profiles that will occur on certain days of the week and not on other days. It can also include specifying certain times during the day and not at other times during the day. Furthermore, the vibrational waveform profile, can specify the amount of time that each vibration will persist.

In step 508, the user couples the cap 124 to the water-tight shell 102. In step 510, the user inserts the vibrating alarm assembly 100 into a body cavity. For example, a female user will insert the vibrating alarm assembly 100 into her vagina a short distance, leaving the tether 130 extending outside the vagina and easily graspable by the user.

In step 512, the user waits for the vibrating alarm assembly 100 to activate, i.e., begin vibrating. This step can include, for example, the user going to sleep. In step 514, the vibrating alarm assembly 100 activates by carrying out the user's selected vibrational waveform profile. In step 516, after an amount of time that suits the user's needs, the user will pull on the tether 130 to remove the vibrating alarm assembly 100 from the body cavity. The process then moves back to step 502 and repeats.

A novel vibrational device 100, 200 has been disclosed that it can be inserted into a body cavity, e.g., a vagina, and will remain dormant until the timer 112 indicates to the controller 120 that it is time for the device to operate. For example, a user can insert, the device 100, 200 prior to going to sleep and, at the preselected time, e.g., morning time, the vibrational device 100, 200 will begin operating. In this usage, the present invention operates as a novel alarm clock. In one embodiment, the vibrational waveform profile causes the device to begin with a low-amplitude vibrating signal and steadily increased to a higher amplitude vibration. The device will operate for a preselected amount of time, for example, approximately 3 min. When the user has finished enjoying the device 100, 200, they can simply pull on the tether 130, which is securely mechanically coupled to the device 100, 200, and remove the device from within the body cavity.

In addition, it has been found that the present invention has novel features that lend themselves to uses other than as a personal pleasure device. As just one example, it is known in the art of fishing that fish are attracted to bait that has some type of movement associated with it. For this reason, many commercially-available fishing lures are provided with features that cause it to move when pulled through the water at some speed. These features include spoon shaped devices at the leading edge of the lure, which cause it to dip and dive. Other lures have propeller-type objects the drag behind them, aerodynamics that cause them to wiggle from side to side, and many more. It has also been found that fish are attracted to other fish that are in distress. Distressed fish emit sounds that other fish are able to interpret as indicating that the distressed fish will make for an easy meal.

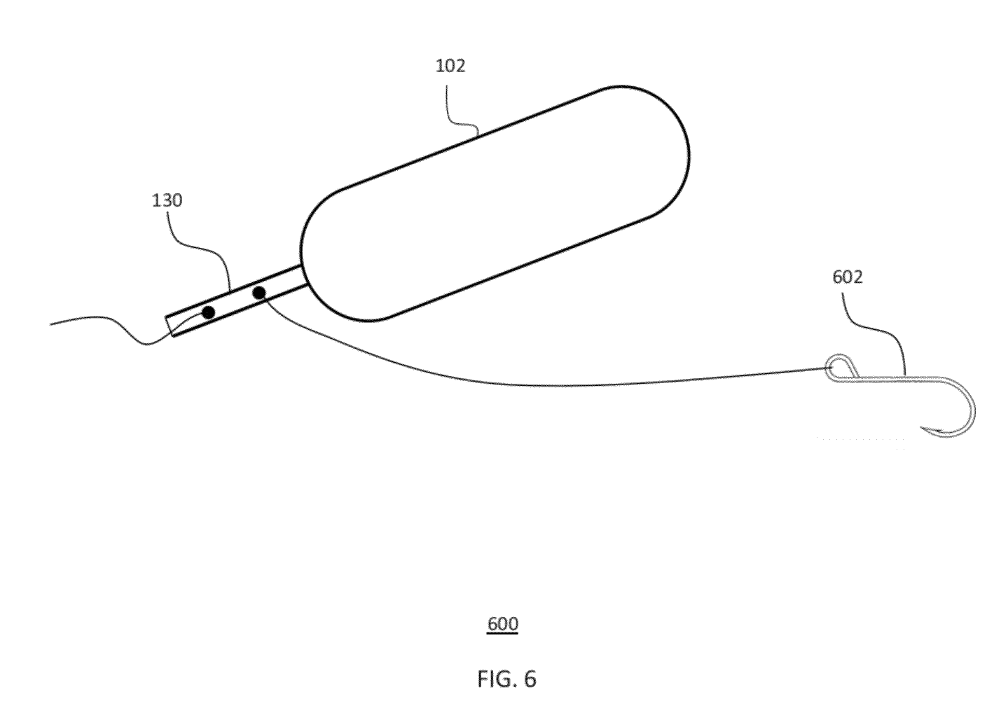

The presently-inventive device 100, 200 described above and shown in the accompanying drawings, in accordance with one embodiment, can be converted to a fishing device 600, shown in FIG. 6, by simply providing the water-tight shell 102 with a fish hook 602 or other fish-capturing mechanism. Advantageously, the water-tight shell 102 protects the internal components from moisture as the device 100, 200 is submerged in water. Through the help of the controller 120 and vibrational profiles stored in memory 116, the vibration-producing element 108 can mimic the same vibrations/sounds produced by distressed fish. These vibrations/sounds will be communicated through the water to nearby fish that will be drawn to the inventive fishing lure. Vibrational profiles that mimic a fish in distress can be captured from recordings of actual sounds produced by a fish in distress. The present invention is not, however, restricted to vibrational profiles that mimic distressed fish. Other vibrational profiles will nevertheless be received by fish and cause the fish to investigate the novel fishing lure. The vibrational profiles can be the same profiles described above.

What is claimed is:

1. A vibrating alarm assembly comprising:
a water-tight shell;
a tether physically coupled to the water-tight shell and partially disposed at an exterior of the water-tight shell;
a power source disposed within the water-tight shell;
a vibration-producing element disposed within the water-tight shell and coupled to the power source; and
a timer disposed within the water-tight shell, communicatively coupled to the vibration-producing element and the power source, and operable to activate the vibration-producing element at a preselected time of day.

2. The assembly according to claim 1, wherein:
the water-tight shell has a longitudinal dimension of less than about two inches.

3. The assembly according to claim 2, wherein:
the water-tight shell has a width of less than about one inch.

4. The assembly according to claim 1, wherein the water-tight shell comprises:
a distal end;
a proximal end opposite the distal end and coupled to the tether;
at least one sidewall between the distal end and a proximal end; and
a smooth transition between the distal end and the at least one sidewall.

5. The assembly according to claim 1, further comprising:
an input; and
a processor:
communicatively coupled to the input;
communicatively coupled to the vibration-producing element;
operable to receive from the input a selection from a user of at least one vibrational waveform profile from at least two vibrational waveform profile choices; and
operable to cause the vibration-producing element to produce the at least one selection of a vibrational waveform profile choice.

6. The assembly according to claim 5, wherein each vibrational waveform profile comprises:
specification of at least one of a vibrational frequency and a vibrational amplitude.

7. The assembly according to claim 5, further comprising:
a memory communicatively coupled to the processor, the memory storing at least two predefined vibrational waveform profiles selectable by the processor for delivery to the vibration-producing element.

8. The assembly according to claim 5, wherein the input comprises:
a wireless receiver.

9. A vibrating alarm assembly comprising:
a water-tight shell defining:
a distal nose portion;
a proximal end portion;
a tubular elongated body portion disposed between the distal nose portion and the proximal portion; and
a smooth transition region between the distal nose portion and the elongated body portion;
a tether physically coupled to the water-tight shell;
a vibration-producing element disposed within the water-tight shell;
a power source disposed within the water-tight shell; and
a timer disposed within the water-tight shell and operable to electrically couple the power source to the vibration-producing element at a preselected time of day.

10. The assembly according to claim 9, wherein the tether is permanently coupled to the assembly.

11. The assembly according to claim 9, further comprising:
a communication port; and
a removable cap at the shell that, when removed, exposes the communication port.

12. The assembly according to claim 9, further comprising:
a wireless receiver disposed within the water-tight shell.

13. The assembly according to claim 9, further comprising:
an input; and
a processor:
communicatively coupled to the input;
communicatively coupled to the vibration-producing element;
operable to receive from the input a selection from a user of at least one vibrational waveform profile from at least two vibrational waveform profile choices; and
operable to cause the vibration-producing element to produce the at least one selection of a vibrational waveform profile choice.

14. A method for waking a user, the method comprising:
providing a vibrating alarm assembly, the assembly including:
a water-tight shell;
a tether physically coupled to the water-tight shell;
a vibration-producing element disposed within the water-tight shell; and
a timer disposed within the water-tight shell, communicatively coupled to the vibration-producing element, and operable to activate the vibration-producing element at a preselected time of day; and
inserting the vibrating alarm assembly within a body cavity of the user.

15. The method according to claim 14, further comprising:
removing the vibrating alarm assembly from the body cavity of the user by pulling the tether.

16. The method according to claim 14, wherein:
the body cavity is the vagina.

17. The method according to claim 14, further comprising:
delivering to the timer at least one vibrational waveform profile selected by the user from at least two vibrational waveform profile choices provided to the user.

18. The method according to claim 17, wherein the timer comprises:
a clock; and
a processor communicatively coupled to the clock and the vibration-producing element.

19. The method according to claim 17, wherein each vibrational waveform profile comprises:
a specification of at least one of a vibrational frequency and a vibrational amplitude.

20. The method according to claim 17, wherein the delivering step comprises:
wirelessly transmitting the selection of a vibrational waveform profile.
